(19) United States
(12) Patent Application Publication
(10) Pub. No.: US 2023/0342786 A1
(43) Pub. Date: Oct. 26, 2023

(54) SYSTEM AND METHOD FOR PREVENTION OF UNINTENDED CHECKOUT

(71) Applicant: MASTERCARD INTERNATIONAL INCORPORATED, Purchase, NY (US)

(72) Inventors: Cristian RADU, Beauvechain (BE); Alan JOHNSON, Maldon (GB)

(21) Appl. No.: 18/027,581

(22) PCT Filed: Aug. 23, 2021
(86) PCT No.: PCT/US2021/047055

§ 371 Date: Mar. 21, 2023

(30) Foreign Application Priority Data
Sep. 22, 2020 (GB) 2014935.7

(51) Int. Cl. G06Q 20/42; G06Q 20/12

(52) U.S. Cl. CPC G06Q 20/425; G06Q 20/123; G06Q 20/3255

(57) ABSTRACT

The invention provides techniques for detecting and responding to potentially unintended checkout operation made by consumers using legitimate payment credentials to initiate the transaction. The invention operates prior to a transaction being approved, rather than after the event, enabling the invention to provide an efficient method of preventing unintended checkout proceeding to actual purchase. Broadly speaking the invention analyses a transaction request in real-time or near real-time and predicts how likely it is that the transaction is unintentional. In cases where it is deemed likely that the transaction is unintentional, the consumer that initiated the transaction is required to confirm that they wish for the transaction to go ahead in order to complete the transaction. The user's confirmation is stored and is available at a later date should the consumer attempt to dispute the transaction. This greatly reduces the likelihood of unintentional transactions being processed.

### CROSS-REFERENCE TO RELATED APPLICATION

This application is the U.S. National Stage Application of International Application No. PCT/US2021/047055, filed Aug. 23, 2021, which claims the benefit of, and priority to, United Kingdom Patent Application No. 2014935.7, filed Sep. 22, 2020. The entire disclosure of the above application is incorporated herein by reference.

### FIELD OF INVENTION

The invention relates generally to the detection of unintended payments and the prevention of the processing of said payments at an early stage of transaction processing. More particularly, the invention relates to the detection and prevention of unintended transactions for purchases of digital goods where the transaction is initiated by the legitimate cardholder of the card used in the transaction.

### BACKGROUND

Increasingly, payment transactions are made electronically using credentials associated with a payment card or a suitably configured electronic device. Such transactions are facilitated by a payment network, which serves (among other things) to provide a route for communication between the various parties involved in the transaction.

Fraudulent use of payment credentials that have been copied or stolen by malicious parties can cause great disruption and costs to legitimate cardholders, merchants and institutions involved in the facilitation of payments. Various methods exist for detecting and preventing fraudulent use of payment credentials in such transactions. The use of cryptographic security features in line with EMV™ standards has provided improved protection against use of fraudulently obtained payment credentials.

Further to the fraudulent transactions described above, another class of costly and disruptive transactions are unintended checkout transactions, in which a consumer unintentionally purchases goods using their legitimate card details and later attempts to deny or reverse the transaction. Unintended checkout can occur in many circumstances, including: when an honest legitimate consumer requests reversal of a transaction after approving it by mistake, where the details of the transaction were unclear to the consumer at the time of approval, or transaction authorization was accidentally supplied (e.g. accidentally tapping a relevant region of a touchscreen). A special case of unintended checkout occurs when a dishonest consumer uses legitimate payment credentials to initiate a transaction and later denies that the transaction was known to the consumer or claims that that the amount for which the transaction was submitted in authorization was bigger than the amount to which the consumer had agreed, despite being aware of all its details (including the shipping costs, etc.) during the transaction. Such cases are most prevalent in relation to transactions involving digital goods, such as online movie streaming, where the purchased goods can be consumed immediately following purchase and therefore before the consumer denies the transaction.

Current cryptographic security features are not able to prevent unintended checkout effectively. As such, there is a need for new security tools for detecting and preventing unintended checkout during the transaction itself, particularly in the context of digital transactions.

### SUMMARY OF THE INVENTION

The invention provides techniques for detecting and responding to potential unintended transactions where the consumer is using legitimate payment credentials to initiate the transaction. The invention operates prior to a transaction being approved, rather than after the event, enabling the invention to provide an efficient method of preventing unintended checkout transactions. Broadly speaking the invention analyses a transaction request in real-time or near real-time and predicts how likely it is that the consumer will later indicate that the transaction was unintentional. In cases where it is deemed likely that the consumer will later deny the transaction, the consumer is presented with additional details of the transaction and required to confirm that they wish for the transaction to go ahead in order to complete the transaction. By presenting the consumer with details of the transaction, the consumer is able to verify that the transaction details are correct before providing further consent to the transaction. The additional consumer consent also provides the consumer with an opportunity to terminate the transaction if the transaction was initiated accidentally. This greatly reduces the likelihood that the consumer will complete an untended checkout transaction. The consumer's confirmation may be stored and made available at a later date should the consumer attempt to dispute the transaction on the grounds that it was made unintentionally.

In a first aspect the invention provides a computer-implemented method for assessing a potentially fraudulent transaction relating to the purchase of one or more goods, the method comprising: receiving, by a fraud prevention service, transaction attribute data from a server of a payment acceptor, the transaction attribute data relating to the transaction; generating, by the fraud prevention service, an unintentional transaction prediction result based on the transaction attribute data; determining, by the fraud prevention service, that the unintentional transaction prediction result is a high-risk result; generating, by the payment acceptor and in response to the determining, a consumer consent request comprising transaction details relating to the transaction and a request for the consumer to provide authorization data confirming the consumer's consent to the transaction; sending, by the payment acceptor, the consumer consent request to a consumer device; receiving, by the payment acceptor, from the consumer device, a consumer consent response in response to the consumer consent request, the consumer consent response comprising authorization data provided by the consumer and the transaction details; and based on the consumer consent response, approving or declining the transaction.

Optional details of the first aspect are set out in the appended dependent claims.

In a second aspect the invention provides a system comprising one or more processors configured to perform the method of the first aspect.

In a third aspect the invention provides a non-transitory computer-readable medium storing computer-readable instructions thereon, the instructions such that, when executed by a processor, the computer-readable instructions cause the processor to perform the method of the first aspect.

### BRIEF DESCRIPTION OF THE DRAWINGS

Embodiments of the present invention are described below, by way of example only, with reference to the accompanying drawings, in which:

FIG. 1 illustrates in schematic form a system suitable for implementing aspects of the invention.

FIG. 2 shows a schematic depiction of various elements of payment acceptor systems and fraud prevention service systems used to detect fraud and steps performed by the systems in an embodiment of the invention.

FIG. 3 shows schematically the steps taken in the present invention subsequent to the assessment of the likelihood of the transaction being initiated unintentionally, as described with respect to FIG. 2.

FIG. 4 is a flow diagram showing steps performed in examples of the present invention.

FIG. 5 is a schematic presentation of the triggering of the Consumer Consent by a modified issuer host logic.

FIG. 6 shows an exemplary scheme for rule-based decision making suitable for use by a rule-based unintended checkout prediction module in examples of the invention.

FIG. 7 shows a table comprising attribute data as produced by an AI prediction module in accordance with an example of the present invention.

FIG. 8 shows a decision tree as structured by an AI prediction module in accordance with an example of the present invention.

FIG. 9 shows in schematic form a data processing device that is suitable for performing the functions of components of the system shown in FIG. 1.

### DETAILED DESCRIPTION

In the following description aspects of the invention are at times described in the context of electronic payments. It will be appreciated however that the invention has application in contexts outside of electronic payments, specifically to any environment in which the legitimacy of an electronic communication may be uncertain and require further verification.

The invention provides a method and system that allows unintended checkout transactions (‘UCT’) to be detected and prevented at an early stage in the authorization process before authorization is complete. Because UCT attempts are detected and prevented prior to the completion of the authorization process, the method avoids costly and technically complex processes for rectification of fraudulent authorizations.

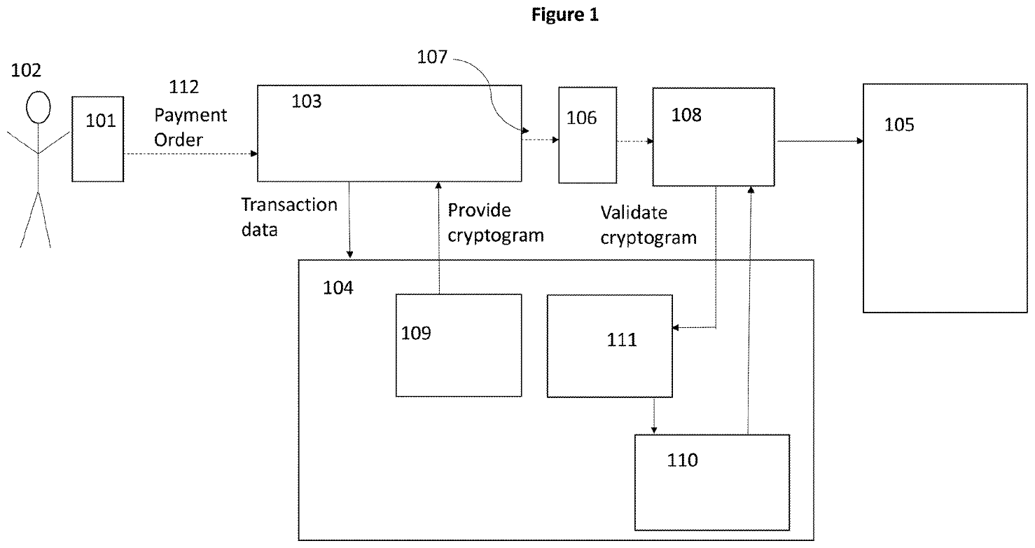

FIG. 1 schematically illustrates a system suitable for use in transaction processing and unintended checkout detection processes in the present invention. The examples illustrated and described below show invention being performed by entities as part of a remote transaction payment model. However, the skilled person should understand that the invention is applicable to other payment models and data transfer schemes.

The prevention of unintended checkout comprises two main stages: a detection stage in which a transaction is detected as being potentially unintended, and a reaction stage, in which further steps are performed to ensure that the transaction is intended and to prevent an unintended transaction being processed. These main stages are described below.

Detection

A consumer 102 has access to an electronic device 101 capable of accessing a digital commerce platform 103 operated by a merchant or payment service provider (PSP) (or other payment acceptor) for the sale of digital goods. The electronic device 101 may be a smartphone, a tablet, a desktop computer, a laptop computer, a games console, or any other suitable device for accessing the digital commerce platform. The digital commerce platform may, for example, be a webpage, a streaming service, a gaming provider, or another such platform. The electronic device 101 has a data connection, such as a 3G, 4G or 5G data connection, WiFi data connection, or Ethernet data connection or another form of data connection enabling communication over a wide area network such as the internet. The electronic device 101 is able to access and exchange data with the digital commerce platform using the data connection. In some examples, the electronic device may also be capable of receiving digital goods, such as electronic copies of movies, music, video games, e-books or other digital representations of content that can be either streamed or downloaded for immediate or later consumption by consumers on specialized devices. In other examples, the purchased digital goods may be provided to a separate digital appliance to the electronic device used to access the digital commerce platform.

During a purchase of digital goods, the consumer makes a payment order 112 to a payment acceptor 103 associated with the digital commerce platform. A payment acceptor 103 is a merchant or payment service provider capable of accepting payments on behalf of a merchant. On receiving the payment order 112, the digital platform with which the merchant is associated generates a transaction authorization request 107 for a payment to be made from the consumer's account at an issuer 105 to the merchant's account at an acquirer 106. The transaction authorization request may be made in accordance with a remote payment method such as the MasterCard Digital Secure Remote Payments (DSRP) process, by adding the transaction cryptogram produced by the Cryptogram Generation Service 109. Processing of the transaction may be performed partly by a core service of a payment network, such as the MasterCard payment network 108, with an unintended checkout prevention service 104, for example implemented as part of the MasterCard Digital Enablement Service (MDES), performing further tasks. During the processing of the transaction, the merchant, acquirer, issuer, payment network core service 108, and unintended checkout prevention service may all perform various processing steps which may lead to the authorization request being accepted or declined. The transaction authorization request message 107, which consists of the transaction financial data and the transaction cryptogram returned by 104, may be an electronic message formatted in accordance with the ISO 8583 standard.

The transaction financial data in 107 may include all or some of: payment credentials (such as a payment card PAN or token unique reference, TUR, an expiry date, an issue date, a card verification code, a sort code, an account number, or other details used to identify a payment account or account holder) that can be used to identify an account at an issuer, a transaction amount, a date and time of transaction, a transaction type (e.g., purchase, money withdrawal, purchase with cashback, etc.)

The message descending from 103 to 104 is distinct from the message 107 in that it comprises transaction data that is used by Cryptogram Generation Service 109 to produce the transaction cryptogram and supplementary product related data (linked to the sort of digital product bought) that helps the service 104 to evaluate whether the current transaction represents a risk for being a UCT. The transaction data message descending from 103 to 104 may include all or some of the transaction financial data mentioned in 107 (to allow the production of the transaction cryptogram). The transaction data message descending from 103 to 104 can include additional information that is not included in message 107, e.g., a product identification code, such as Stock Keeping Unit (SKU) or Unified Product Code (UPC), the name of the merchant, a Purchase Order Number, a Customer Code and a Tax Amount, as well as additional data contained within the invoice and Line Item Details (LID) objects.

An SKU is a unique identifier for an item in the merchant's inventory, such as a product or a service, which can be used to identify all the attributes connected with the item that distinguish it from other items. These attributes might include but are not limited to the brand, size, color, manufacturer or warranty. Thus, an SKU encodes information about an item to allow tracking and recalling a particular item easily. Since the code holds all the relevant information about the item, someone able to access and interpret the code can obtain all relevant information about the item without having to inspect the object itself.

A UPC is similar to an SKU, but the UPC is standardized among the manufacturers of the same product, while the SKU is established by each merchant depending on their storage space configuration. The standardization body of UPC is the Uniform Code Council, known as GS1. The current standards require a code comprising 12 digits and it is extensively used in US and many other countries.

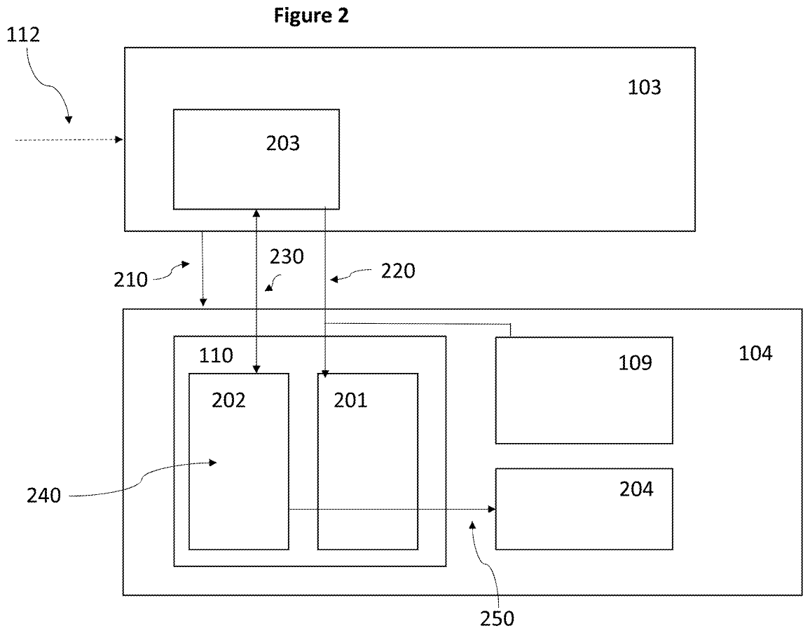

On receiving a payment order from the consumer, the payment acceptor 103 begins processing of the transaction including unintended checkout detection, as described in more detail with reference to FIG. 2. The payment acceptor 103 provides transaction data and product details to an unintended checkout prevention service 104 for use in unintended checkout prevention processes.

The unintended checkout prevention service 104 performs two main functions. Firstly, the unintended checkout prevention service 104 provides a “detection” service, in which an assessment of the transaction is performed in order to determine whether it is likely that the transaction was unintentional. Secondly, if the result of the detection service is that the transaction is likely to be unintentional, the unintended checkout prevention service 104 provides a “reaction” service, in which the transaction is either prevented or the consumer is prompted to provide additional confirmation that the consumer wishes to proceed with the transaction.

In some cases, the payment acceptor uses an API to contact and provide data to the unintended checkout prevention service 104. The unintended checkout prevention service 104 is a service capable of performing several transaction processing functions, including generating transaction cryptogram information (to prevent the counterfeit threat), performing evaluations of risk and fraud likelihood, performing evaluation of the likelihood of a transaction being unintentional, receiving and sending secure messages from issuers, acquirers and payment network elements, and other suitable tasks. For example, the unintended checkout prevention service 104 may comprise the functionality of the existing MasterCard Digital Enablement Service (MDES) with the additional functionality described within the present disclosure.

The unintended checkout prevention service 104 generates a cryptogram based on the transaction request data and the payment credentials. The cryptogram is suitable for preventing fraud performed by malicious parties using stolen payment credentials and may be based on the payment amount and the merchant name and be generated using a single use key derived using the payment credentials. The cryptogram may incorporate dynamic data relating to the transaction, for example, in accordance with the MasterCard Digital Secure Remote Payments (DSRP) method, or another suitable remote payment method that preferably provides EMV™ level security. When the cryptogram is received by the payment network core service 108 in the transaction authorization message it is passed back to the unintended checkout prevention service 104 for verification to the cryptogram validation service 111.

The unintended checkout prevention service 104 also performs an assessment of the likelihood that the consumer will later deny the transaction due to the transaction being unintentional by processing the transaction data. The result of the assessment is a prediction of either “YES” or “NO” in response to the question of whether the consumer is likely to later deny the transaction. The prediction is generated by an unintended checkout prediction module 110 of the fraud prevention service 104 based on the transaction data. In the example described with reference to FIG. 2, the unintended checkout prediction module 110 comprises a rule-based prediction module and an AI prediction module, which are used in succession to determine the risk level of a transaction. The skilled person will understand that the invention can be modified to use only the rule-based prediction module or only the AI prediction module to provide an unintended checkout prediction result. In some examples, the result of the prediction may be provided to the payment network core service 108 along with a verification result of the cryptogram. The result of the cryptogram verification performed by the cryptogram validation service 111 is amended with the prediction YES/NO of whether the transaction is susceptible of being an UCT.

If the unintended checkout prediction result is “NO” (i.e. the transaction is deemed to have a low risk of being unintentional) then the unintended checkout prevention service 104 processes the transaction as normal and provides an indication to the payment network core service 108, and further on to the issuer 105, to process the transaction as normal.

If the unintended checkout prediction result is “YES” (i.e. the transaction is deemed to have a high risk of being unintentional), the unintended checkout prevention service 104 will trigger the reaction stage of the unintended checkout prevention.

Reaction

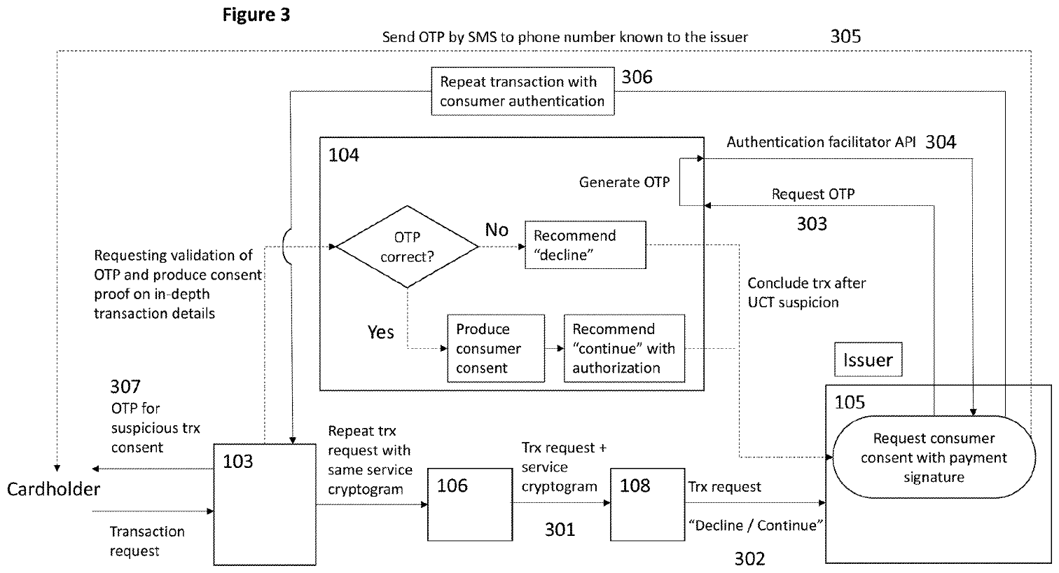

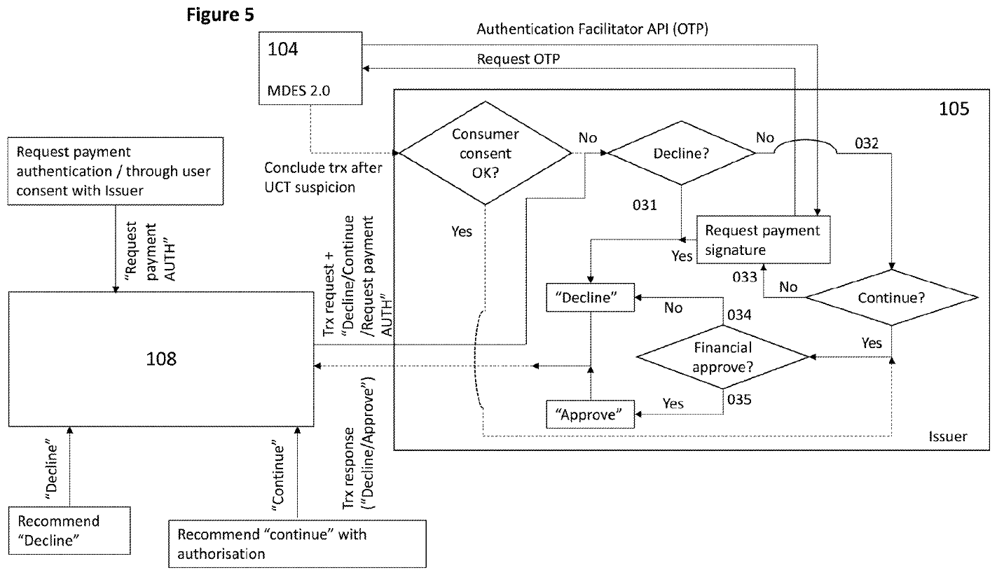

After determining that the transaction has a high risk of being unintentional, then the unintended checkout prevention service will trigger a new “request consent” process from the issuer 105. As described in more detail in FIGS. 3 and 5 the request consent process causes the consumer to be presented with detailed transaction information data and provided with a means for securely authenticating the detailed transaction information data, such as a one-time password (OTP) provided to the consumer via a pre-established trusted channel. As the consumer is provided with detailed transaction information data and is required to provide additional consent before the transaction is authorized, the likelihood of an unintentional transaction being authorized is greatly reduced. In the case where the UCT prediction result is “YES”, the issuer instructs the merchant 103 to authenticate the consumer and ask his/her consent on the details of the purchase and generate a new authorization request for sending to the issuer 105. The merchant 103 also provides the detailed transaction data and the consumer's authentication of the detailed data to the unintended checkout prevention service 104.

If the consumer has correctly authenticated the detailed transaction data, the unintended checkout prevention service 104 will store the detailed transaction data and the consumer's authorization by the unintended checkout prevention service 104 to prevent repudiation of the transaction by the consumer 102 at a later time. The unintended checkout prevention service 104 may have access to a storage medium for this purpose.

Failure to correctly authenticate the detailed transaction data may result in the transaction being declined; e.g. the unintended checkout prevention service 104 may decline the transaction outright or may provide a recommendation to another party such as payment acceptor 103 or issuer 105 that the transaction should be declined.

After successful verification of the consumer authentication, his/her consent is obtained on all the transaction data, including the digital item details. The unintended checkout prevention service 104 provides an indication to the issuer 105 that the new authorization request can be accepted provided that other aspects of transaction processing, such as account balance checks, are completed successfully. These aspects are completed in a conventional manner and so are not described in detail here.

The merchant 103 then sends the updated authorization request message to the payment network core service 108 for further processing and forwarding to the issuer.

Upon receiving the updated authorization request, the issuer 105 determines that the unintended checkout prevention service 104 has sent an indication that the transaction authorization request can be accepted. The issuer 105 performs further standard checks on the transaction data, including a balance check on the consumer's payment account. If the additional checks are passed, the issuer 105 provides a positive authorization request response to the payment network core service 108 for forwarding to the merchant 103. The merchant 103 may then conclude the transaction. If the consumer later denies the transaction, the detailed transaction information data and the consumer consent information can be presented to show that the consumer was responsible for and aware of the transaction. This makes it far easier for the merchant or other provider of the goods to resolve intentional transactions which a dishonest consumer claims were unintentional, because the detailed transaction information data and consumer consent make it very difficult for the consumer to successfully argue that the goods were purchased accidentally, or without their knowledge.

FIG. 2 shows a schematic depiction of various elements of payment acceptor systems and unintended checkout prevention service systems used to detect unintended checkout and steps performed by the systems in an embodiment of the invention. In the example below, the unintended checkout prediction module 110 comprises a rule-based prediction module 201 and an AI prediction module 202 that are in combination to process potentially unintended checkout transactions, but the skilled person should understand that in other embodiments the AI prediction module 202 or the rule-based prediction module 201 may be used alone.

In step 210, after receiving a payment order 112 from the consumer, the merchant 103 sends a request to the unintended checkout prevention service 104 for the unintended checkout prevention service 104 to:
a) Generate a cryptogram for protection against fraud, and
b) Perform an assessment of the likelihood of the transaction being unintentional.

The request of step 210 comprises an indication of the type of goods that the transaction relates to, e.g., digital goods, and an indication of the appliance used to purchase the goods. In the case of digital goods, this appliance may be also used to consume the goods, e.g. to purchase and watch a movie, purchase and listen to an audio track, purchase and read a digital book, etc.

The request of step 210 preferably also comprises transaction data for use by the cryptographic module 109 in generating the cryptogram and may be made by the merchant 103 using an API designed by the payment network or the unintended checkout prevention service 104. The transaction request data used to generate the cryptogram should be the same data to be included in an authorization request message from the merchant 103 in order to allow the contents of the authorization request message to be verified by the cryptogram validation service 111 using the cryptogram. The transaction request data for inclusion in a cryptogram may comprise: the transaction amount, payment credentials, date and time of transaction, transaction type (purchase, money withdrawal, purchase with cashback, etc.), and name of the merchant. The transaction request data is provided for digital signing by a cryptographic module 109 of the unintended checkout prevention service 104 to generate a cryptogram for protection against fraud as is known in the art per se.

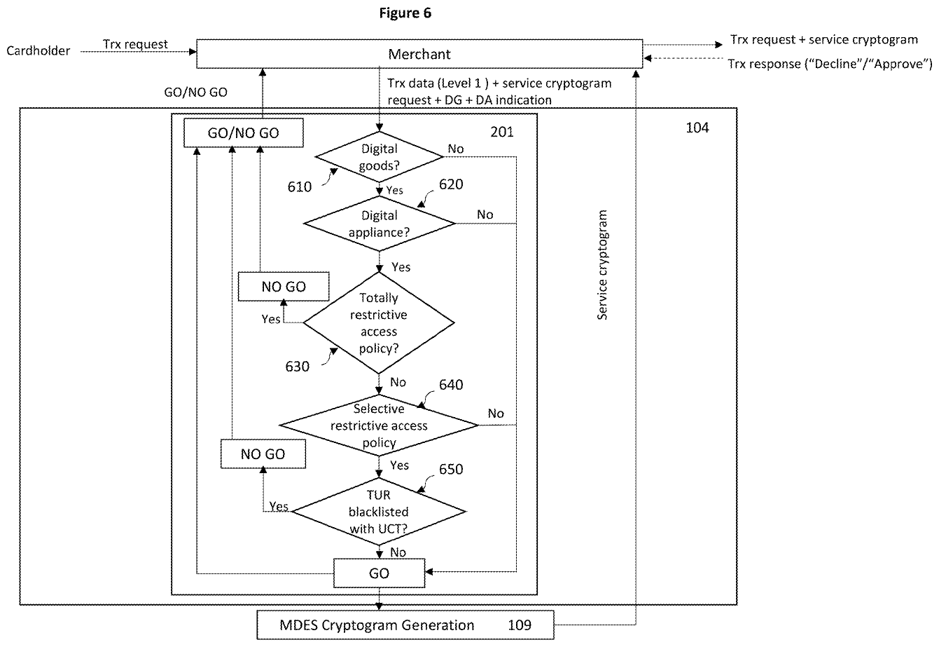

In step 220, the unintended checkout prevention service 104 uses the indication of the digital goods and the digital appliance and, in some cases, the transaction request data as inputs in a rule-based prediction module 201 of the unintended checkout prevention service 104. As described in more detail in association with FIG. 6, the rule-based prediction module 201 assesses the input data in accordance with a series of predetermined rules in order to provide a prediction of the likelihood of the transaction being unintentional. The predetermined rules may, for example, be set by the issuer 105. In response to the input data, the rule-based prediction module provides as an output either “GO”, for low-risk transactions, or “NO GO”, for high-risk transactions.

If the decision of rule-based prediction module 201 is “NO GO”, the unintended checkout prevention service 104 sends a message to the merchant 103 indicating that the transaction should be terminated. Processing of the e-commerce transaction stops at this point and the consumer receives a notification that the transaction was declined.

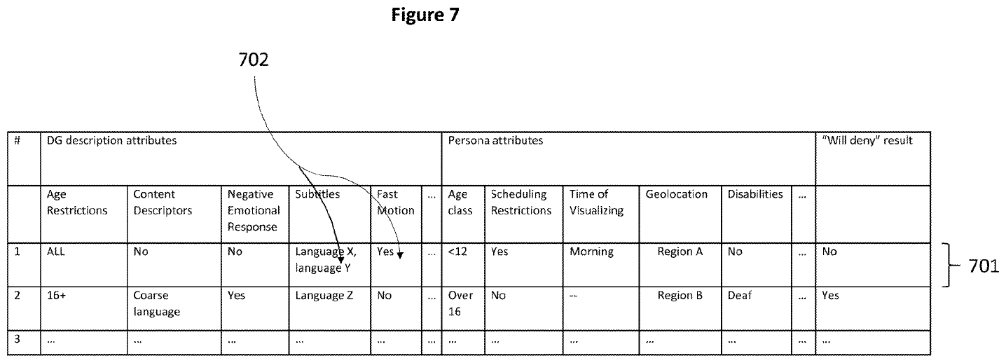

In step 230, the merchant 103 calls an artificial intelligence prediction module 202 of the unintended checkout prevention service 104 for further analysis of the transaction, as described in more detail in association with FIGS. 6 and 7. The merchant 103 maintains an item details module 203 that includes detailed data relating to the goods provided by the merchant and anonymized consumer profiles of a number of consumers. The merchant 103 provides the AI prediction module 202 with further transaction information data from the item details module 203 in addition to the transaction information data used by the rule-based prediction module 201. In particular, the further transaction information data (or “transaction attribute data”) includes more detailed information regarding attributes of the goods being purchased and the consumer. In the case of digital goods, the additional attribute information may include:
A category of digital good. For example, Video-On-Demand (VOD), Broadcasting (usual TV, radio), or Video Sharing Platforms.
A genre of the digital goods. For example, the genre for a movie may be categorized as comedy, drama, historic, etc.; the genre for music may be categorized as jazz, symphonic, rock, etc.; the genre for video games may be categorized as action, simulation, role-playing, etc.
An age restriction applied to the digital good. For example, a motion picture content rating or video game content rating as certified by a content rating system.
A content descriptor relating to the digital goods. For example, violence, fear, discrimination, coarse language.
A warning of a potential negative emotional response. For example, a warning that the content may trigger posttraumatic stress.
A fast motion warning, indicating whether the digital good contains fast images that may trigger an epileptic crisis.
A publishing date of the digital good.
A production director, when the digital good is a video file, such as a movie.

Suitable additional attribute information for other forms of good will be apparent to a skilled person having the benefit of the present disclosure.

The additional data provided by the merchant 103 also includes persona attributes schema data. The persona attributes schema data represents attributes that characterize an anonymized consumer as is known to the merchant 103.

The consumer persona data may include indications of consumer characteristics including any one of more of:
Gender
Age class, one value from the set: child (younger than 12 years), teenager (older than 12 and younger than 16 years), youngster (older than 16 and younger than 25 years), young (older than 25 but younger than 40), mature (older than 40 but younger than 60), senior (higher than 60).
Languages, one or more values of the set of ISO values for: English, French, German, Russian, Spanish, etc.
Scheduling Restrictions, one or more values of the set: no playing on working days, no watching outside holidays, etc.
Time of visioning, one value from the set: morning, evening, etc.
Disabilities: None, Deaf, Hard-of-Hearing, epilepsy, motoric, etc.

This list is non-exhaustive and other items suitable for inclusion in the consumer persona data will be apparent to a skilled person having the benefit of the present disclosure.

The data representing additional information about the goods and the consumer profile is at times collectively referred to herein as the “transaction attribute data”. Both the transaction attribute data and the transaction request data included are at times referred to herein as “transaction information data”.

In some embodiments, the unintended checkout prevention service 104 initially receives only transaction request data from the authorization request, including a UPC or SKU and an identifier of the consumer. The unintended checkout prevention service 104 then sends a request to the merchant 103 to retrieve the transaction attribute data about the goods and the consumer profile described above from the merchant 103. For example, the merchant 103 may operate an item detail module that may be accessed by the unintended checkout prevention service 104 via an API. Upon presenting the UPC information relating to the good(s) being purchased, the API will return an attributes value message comprising the transaction attribute data relating to the good(s) and the consumer profile.

In step 240, the transaction attribute data is used as an input to the AI prediction module 202 to generate a prediction of whether the consumer is likely to later deny the transaction in the form of a “YES”/“NO” answer. The prediction is based on a decision tree whose structure is determined by previous training and adaptation of the decision tree based on previous transactions. Further details of this decision tree are provided in connection with FIG. 7.

The attributes values may also be provided to an adaption module of the AI prediction module 202. The adaptation module uses the attributes values along with the outcomes of previous transactions (i.e., whether the consumer has a history of denying transactions) to modify the decision tree structure of the AI prediction module 202. This is useful in cases where the attributes values comprise information that has not yet been encountered in the training set or in previous transactions. The running of the adaption module may happen offline as it may be time-consuming.

In step 250, the prediction result of the AI prediction module 202 is provided to a decision module 204 of the unintended checkout prevention service 104. Based on the prediction result, the decision module 204 will trigger further steps, either allowing the transaction to proceed or requesting additional consent from the consumer.

If the prediction result is “NO” (i.e., the consumer will probably not deny having intentionally initiated the transaction), the decision will be “Continue”. This means that unintended checkout prevention service 104 will continue the authorization process to evaluate the transaction financial result without further unintended checkout checks.

If the prediction result is “YES” (i.e., the consumer will probably deny having intentionally initiated the transaction), the decision will be “Request Consent”. In this case, the unintended checkout prevention service 104 will continue to process the transaction while requiring additional consumer consent, as described below with respect to FIG. 3.

An indication of the decision of the decision module is provided to the payment network core service 108 for use in processing the transaction.

The unintended checkout prevention service 104 may send a message to the core payment processing network 108 indicating whether the transaction is likely to be denied by the consumer.

The cryptogram is sent to the merchant 103 for inclusion in an authorization request message to be provided to the issuer via the core payment processing network 108.

The merchant 103 generates an authorization request message for the transaction including the transaction details and the cryptogram based on the transaction details.

The merchant 103 sends the first authorization request message to the core payment processing network 108 for processing.

FIG. 3 shows schematically the steps taken in the present invention subsequent to the assessment of the likelihood of a transaction being unintentional described with respect to FIG. 2.

Upon receiving (at 301) the authorization request message from the merchant 103, the payment network core service 108 performs further processing of the authorization request message, e.g. calling the unintended checkout prevention service 104 to validate the cryptogram of the authorization request to prevent fraud. If the authorization request fails the criteria of the transaction processing, for example because the cryptogram cannot be validated, the payment network core service 108 will send a recommendation to the issuer 105 to “decline” the authorization request in accordance with conventional transaction processing. If the authorization request message is processed successfully, the payment network core service 108 determines whether the prediction result of the unintentional transaction AI prediction module 202 was “YES” or “NO”.

In the case that the prediction result of the AI Prediction module 202 is “NO” (i.e., the transaction is a low-risk transaction from a UCT perspective), the payment network core service 108 sends the authorization request message to the issuer 105 along with a “continue” indication. The “continue” indication indicates to the issuer 105 that the authorization request should be processed as usual. The issuer processes the transaction as usual and, if the authorization request passes the issuer's checks, the issuer will send an authorization response message indicating approval to the payment network core service 108 for forwarding to the merchant 103 in response to its first authorization request message.

In the case that the prediction result of the AI Prediction module is “YES” (i.e., the transaction is deemed to be a high-risk transaction from a UCT perspective), the payment network core service 108 sends (at 302) the authorization request message to the issuer 105 along with a “request consumer consent” indication. The “request consumer consent” indication indicates to the issuer 105 that the issuer 105 should decline the transaction and request a further repeat authorization request comprising further consumer consent information and should not approve the authorization request until consumer consent information has been provided and successfully validated.

On receiving the authorization request message, the issuer 105 processes the authorization request message according to the following logic, as further illustrated with respect to FIG. 5.

If the payment network core service 108 provides the authorization request message with a decline recommendation, the issuer 105 immediately returns an authorization decline to the payment network core service 108.

If the payment network core service 108 provides the authorization request message with a “continue” recommendation, the issuer performs conventional checks such as whether the account balance is sufficient. If the checks are failed, the issuer 105 returns an authorization decline to the payment network core service 108. If the checks are passed, the issuer 105 returns an authorization approval to the payment network core service 108.

If the payment network core service 108 provides the authorization request message with a “request consumer consent” indication, the issuer 105 requires that the merchant provides a second, repeat authorization request. The issuer further requires that the merchant obtains further consumer consent authentication from the consumer, which is provided through an API channel to the unintended checkout prevention service 104. The repeat authorization request will only be approved after the issuer 105 has determined that the consumer has provided the further consumer consent authentication. This ‘request consumer consent’ is a new category of message from the perspective of the issuer 105.

The issuer 105 contacts an authentication facilitator module (at 303) of the unintended checkout prevention service 104, e.g. via an API call, and requests a new one-time password (OTP) to be generated and sent to the issuer 105. The OTP may, for example, be a 6 to 8 digit code. Other suitable forms for the OTP will be apparent to a skilled person having the benefit of the present disclosure.

The issuer 105 receives (at 304) the OTP from the unintended checkout prevention service 104, e.g. via an API call, and sends (at 305) the OTP to the consumer via a pre-established trusted channel. For example, the issuer 105 may send the OTP to the consumer via text message to a telephone number known to the issuer 105 to belong to the consumer. While, in this example, the authorization data is the OTP generated by the unintended checkout prevention service 104, the skilled person will understand that in other examples the OTP may be generated by the issuer or another party.

The issuer 105 sends a further instruction (at 306), e.g. via another API call, to the merchant 103 to obtain explicit consumer consent from the consumer and to repeat the transaction with the an indication that consumer consent has been provided via an API channel.

The merchant 103 presents the consumer with a consumer consent request. The consumer consent request comprises transaction details in relation to the transaction and a prompt for the consumer to provide authorization data to confirm consent to the transaction on the basis of the provided information. The transaction details may include any of: a description of the good(s) being purchased, a transaction amount of the good(s), a description of any further conditions on the purchase, and any other transaction information data considered pertinent to the consumer's decision to proceed with the purchase. For example, the consumer may be presented with the payment amount and a description of the good(s) being purchased. In some embodiments, the user is presented with some or all of the transaction information data included in the authorization request. The transaction details may be presented to the consumer in a pop-up window on a web browser, for example, or by another format appropriate to the digital commerce platform used to purchase the goods.

The merchant 103 further presents the consumer (at 307) with an input box for providing user input and prompts the consumer to enter the OTP to confirm that the transaction information data are correct and that the consumer consents to the transaction. Advantageously the modifications required to the merchant's systems to enable the present invention to be implemented are minimal or none, e.g., the merchant may simply need to configure their systems to allow the pop-up window.

The merchant 103 provides the transaction details and the user input to the unintended checkout prevention service 104 via an API channel. The unintended checkout prevention service 104 checks that the user input matches the generated OTP provided to the issuer 105. If a match is found, the unintended checkout prevention service 104 generates a consumer consent signature using a private key associated with the consumer for which the issuer 105 has a corresponding key. The consumer consent signature may be formed by signing the information presented to the consumer when requesting consent. The unintended checkout prevention service 104 sends the consumer consent signature to the issuer 105 via an API channel and provides a recommendation that the issuer 105 should continue to process the repeat authorization request in the normal manner. The issuer 105 will verify the consumer consent signature before processing a repeat authorization in the normal manner.

If a match is not found, the unintended checkout prevention service 104 will send an indication to the issuer 105 that the consumer authentication information has not been validly provided along with a recommendation that the issuer 105 declines the transaction.

After receiving the demand of Consumer Authentication from the issuer 105 via an API the merchant 103 generates a new (repeat) authorization request message on the payment network comprising the details from the first authorization request, including the cryptogram the first authorization request, and sends the authorization request to the payment network core service 108 for forwarding to the issuer 105. The payment network core service 108 processes the new authorization request message, including validating that the received cryptogram in the second payment authorization request which required consent is the same with the cryptogram sent in the first authorization request. If cryptograms do not match, a “Decline” is recommended, while if they match a “Continue” indication is sent to the issuer host.

The payment network core service 108 then sends the new (repeat) authorization request message to the issuer 105 for authorization.

The issuer 105 processes the new (repeat) authorization request message (which is the second authorization request relating to the same payment transaction). The issuer determines that it has received a consumer consent signature associated with the transaction from the unintended checkout prevention service 104 and validates the consumer consent signature. If the consumer consent signature is successfully validated, the issuer performs normal financial checks on the transaction. If the issuer's checks are successful, the issuer 105 provides a positive authorization response message to the payment network core service 108 for forwarding to the merchant to approve the transaction.

The skilled person will understand that in other embodiments, various aspects of the above exemplary embodiment may be modified to achieve the result of preventing transactions that are likely to be unintentional from proceeding without non-repudiation protection being put in place. Such modifications are also within the scope of the invention. For example, the authentication information of the consumer consent response may not comprise an OTP and may be generated according to an alternative method to the one described above. For example, the transaction details presented to the consumer may be authenticated using biometric data from the consumer that can be validated by the unintended checkout prevention service 104, such as fingerprint data that is stored on a server of the unintended checkout prevention service 104. Furthermore, in some examples, the initiation of the consumer consent request may be initiated by a party other than the issuer. For example, the unintended checkout prevention service 104 or the merchant may initiate steps to obtain detailed consumer consent in response to a prediction that the consumer is likely to deny the transaction.

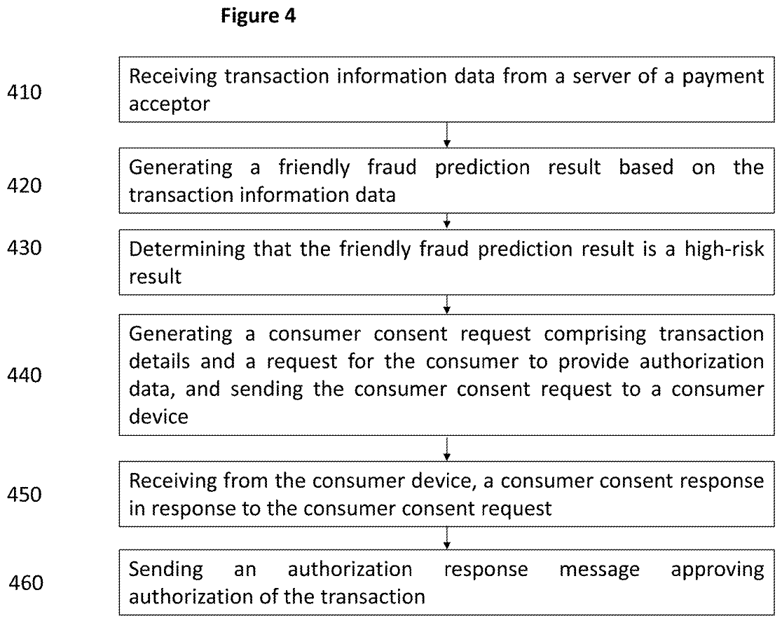

FIG. 4 is a flow diagram showing steps performed in embodiments of the present invention as part of processing a transaction.

Prior to step 410, a consumer 102 initiates a transaction at a digital commerce platform of a payment acceptor 103 using the consumer device 101 and provides authorization information, such as a password or payment card number. The payment acceptor 103 generates an authorization request message for the transaction to be forwarded to an issuer 105 for approval.

Before sending the authorization request message to the issuer 105, the payment acceptor 103 sends transaction information data to an unintended checkout prevention service 104 to assess the likelihood of the transaction being later denied by the consumer 102 on the grounds that the transaction was unintentional. The unintended checkout prevention service 104 may also generate a cryptogram to protect against fraud.

In Step 410, the unintended checkout prevention service 104 receives the transaction information data from a server of a payment acceptor 103.

The transaction information data may be the transaction request data included in the transaction authorization request, including the transaction amount, the merchant name, the payment credentials etc. In other cases, such as the embodiment described with respect to FIG. 2, the transaction information data may include transaction attribute data for the transaction that the unintended checkout prevention service 104 has requested from the payment acceptor 103 after performing an initial analysis based on the transaction request data.

In Step 420, the unintended checkout prevention service 104 generates an unintended checkout prediction result based on the transaction information data.

The unintended checkout prediction result indicates whether the transaction is considered high-risk or low-risk of being unintentional. For example, the unintended checkout prediction result may be a response of “YES” or “NO” to the question “will the consumer deny the transaction?”

In one embodiment, the unintended checkout prediction result may be generated by an AI prediction module 202. In another embodiment, the unintended checkout prediction result may be generated by a rule-based prediction module 201. In a further embodiment, the unintended checkout prediction result may be generated by a combination of a rule-based prediction module 201 and an AI prediction module 202. The prediction may be based on transaction request data included in the transaction authorization request or on transaction attribute data provided by the merchant, or on both.

In Step 430, the unintended checkout prevention service 104 determines that the unintended checkout prediction result is a high-risk result. For example, the unintended checkout prevention service determines that the unintended checkout prediction result is “YES” to the question “will the consumer deny the transaction?”

In another embodiment, the unintended checkout prevention result may return “NO GO” for high-risk transactions.

On determining that the unintended checkout prediction result is high-risk, the unintended checkout protection service sends a recommendation to the issuer 105 or to a core service 108 of a payment network that the transaction should not be approved until further consumer consent has been received.

In Step 440, the payment acceptor 103 generates a consumer consent request comprising transaction details and a request for the consumer 102 to provide authorization data and sends the consumer consent request to a consumer device 101. The consumer device may be a mobile phone, laptop, desktop, tablet, games console, smart TV, etc. The consumer device 101 may be the same device used by the consumer 102 to access the digital commerce platform to initiate the transaction, or a different device known to be owned by the consumer 102.

The authorization data may be an OTP generated prior to the authorization request. In one embodiment, the issuer 105 requests generation of an OTP by the unintended checkout prevention service 104. The unintended checkout prevention service 104 sends a newly generated OTP to the issuer 105 for sending to a consumer device via a trusted channel. The issuer then sends the OTP to the consumer via the trusted channel, such as an SMS to a telephone number known to belong to the consumer 102.

The transaction details in the consumer consent request may comprise some or all of the transaction request data and the transaction attribute data. For example, the transaction details may comprise a description of the good(s) being purchased and the purchase amount.

The consumer is also presented with a prompt for providing the authorization data to the merchant.

Where the authorization data is an OTP, the consumer may be provided with an input box for providing user input and a message asking for the OTP to be entered into the input box. In another example, the prompt may ask the consumer to provide biometric data. For example, the consumer may be prompted to provide fingerprint data using a fingerprint sensor of the consumer's device.

In Step 450, the payment acceptor 103 receives a consumer consent response in response to the consumer consent request from the consumer device.

The consumer consent response comprises the transaction details presented to the consumer and the authorization response data provided by the consumer.

The payment acceptor 103 provides the consumer consent response to the unintended checkout prevention service 104 for validation. The consumer consent response may be sent as a data message using an API designed for this purpose. The unintended checkout prevention service 104 has access to consumer authorization data and is able to validate the data provided in the consumer consent response by the consumer.

In examples where the authorization data is an OTP, the payment acceptor 103 has access to the OTP due to having earlier generated the OTP. In examples where the authorization data is other data, such as biometric data, the consumer 102 may provide authorization data to the unintended checkout detection service 104 via the consumer device 101 at an earlier time when registering a payment device or method, e.g. as part of an enrolment or on-boarding process.

Upon successful validation of the authorization data, the unintended checkout prevention service 104 generates a consumer consent signature based on a private key associated with the consumer. The consumer consent signature is sent to the issuer 105 via an API channel along with a recommendation to the issuer 105 that the transaction authorization request can now be processed as normal and approved.

The payment acceptor 103 generates anew (repeat) transaction authorization request comprising the data from the original authorization request. The new transaction authorization request is sent from the payment acceptor 103 to the issuer 105 via the core service 108 of a payment network.

The issuer 105, on receiving the transaction authorization request, validates the consumer consent signature and determines that it has received an indication from the unintended checkout prevention service 104 that the transaction authorization request can be approved. The issuer 105 performs standard processing checks on the transaction authorization request, such as determining that the consumer's account has sufficient funds for the transaction. After performing processing of the transaction authorization request, if the request passes the checks, the issuer 105 generates a transaction authorization response approving the transaction. The issuer 105 sends the transaction authorization response to the payment acceptor 103 via the payment network core service 108 to approve the transaction.

The payment acceptor 103 can then provide the good(s) to the consumer. If the consumer attempts to repudiate the transaction at a later date, the stored consumer consent response can be used to provide evidence that the consumer was aware of an authorized the transaction details of the transaction authorization request.

FIG. 5 shows flow diagram illustrating the logic used by the issuer 105 to determine how to process transactions in the present invention.

On receiving an authorization request message from the payment network core service 108, the issuer 105 determines whether the payment network core service 108 has recommended the transaction be declined. If so, the transaction is immediately declined.

In not, the issuer 105 determines whether the payment network core service 108 has recommended the transaction be approved. If so, the issuer performs financial checks. If the financial checks are failed, the authorization is declined. If the financial checks are passed, the authorization is approved. The financial checks are known in the art per se and are not described in detail here.

If the payment network core service 108 has recommended the transaction be approved with consent, the issuer 105 sends an instruction to the merchant for a repeat of the transaction with additional consumer consent. The issuer 105 also requests generation of an OTP from the unintended checkout prevention service 104 for sending to the consumer for use in providing consumer consent with non-repudiation.

The merchant presents the consumer with details of the transaction and receives the OTP in return. The transaction details and OTP are sent by the merchant to the unintended checkout prevention service 104. The merchant sends repeat authorization request message for the transaction to the payment network core service 108 for processing.

On receiving the consumer consent, comprising the OTP, from the merchant, the unintended checkout prevention service 104 generates a consumer consent signature based on the transaction details and OTP and sends this to the issuer 105 along with a recommendation to “continue with the authorization”.

Upon verifying the consumer consent signature, the issuer 105 may then authorize the repeat authorization request message sent by the merchant.

The second authorization request will always conclude with a final “Decline” or “Approve” after consumer's positive authentication and consent on the transaction details.

FIG. 6 shows an exemplary scheme for rule-based decision making suitable for use by a rule-based unintended checkout prediction module 201 in embodiments of the invention. This embodiment sets out rules that are particularly suited for use in connection with transactions involving digital goods. Alternative forms for rule-based module 201 suitable for use with other types of good will be apparent to a skilled person having the benefit of the present disclosure.

The rule-based prediction module 201 runs a prediction scheme comprising a number of rules that can operate on input data relating to the transaction in order to generate a prediction. The input data comprises transaction information data, which may include transaction authorization data contained in the transaction authorization request, transaction attribute data provided by the payment acceptor 103, or both. The following non-exhaustive list provides examples of transaction information data that may be considered by the rule-based prediction module 201:
Purchase Type Indication: the fact that the purchase is for a particular type of good, e.g., digital goods that can be “consumed” by a specified appliance.
   Goods description—detailed description of the goods content.
   Persona Description—anonymized description of the consumer.

In this example, a rule may combine attributes from the three categories mentioned above, as in the below example:
If (Purchase=Digital Goods) AND (Digital Goods Category=Video-On-Demand) AND (Digital Goods readable with Digital Appliance=Apple TV+) AND (Digital Goods Age Restriction=16+) AND (Digital Goods Content Descriptor=“Violence” Or “Coarse language”) AND (Persona gender=*) AND (Persona Age Class=Teenager) Then NO GO

The unintended checkout prevention service 104 initially receives a request for unintended checkout assessment and cryptogram generation from a merchant 103. The request comprises an indication to the unintended checkout prevention service 104 that a transaction is being initiated for a certain good, e.g., a certain digital good that is usable on a particular appliance, and includes transaction request data including payment credentials, such as the PAN or the Token Unique Reference (TUR).

In Step 610, the unintended checkout prevention service 104 determines from the request whether the transaction is for digital goods. If not, the unintended checkout prevention service 104 returns GO. If yes, the unintended checkout prevention service 104 proceeds to Step 620.

In Step 620, the unintended checkout prevention service 104 determines from the request whether the transaction is for use with an appliance (such as a gaming console). If not, the unintended checkout prevention service 104 returns GO. If yes, the unintended checkout prevention service 104 proceeds to Step 630.

In Step 630, the unintended checkout prevention service 104 determines whether the payment credentials are associated with an issuer belonging to a list of issuers that apply a totally restrictive access policy to transactions for digital goods, i.e., purchase of digital goods is entirely forbidden irrespective of the specifics of the digital goods. The unintended checkout prevention service 104 can identify the issuer 105 associated with the PAN/TUR from the number range of the PAN/TUR. For transactions associated with issuers on this list, the unintended checkout prevention service 104 returns NO GO without needing to perform any further processing. Otherwise, the unintended checkout prevention service 104 proceeds to Step 640.

In step 640, the unintended checkout prevention service 104 determines whether the payment credentials are associated with an issuer belonging to a list of issuers that apply a selective restrictive policy. The list contains all the PAN or TUR for which the issuer applies a selective declining policy, depending on whether the consumer has been blacklisted as being associated with unintended checkout with a digital good in the past.

When the PAN/TUR belongs to an issuer that does not apply selective restriction, the unintended checkout prevention service 104 returns GO.

When the PAN/TUR belongs to an issuer that does apply selective restriction, the unintended checkout prevention service 104 proceeds to Step 650.

In Step 650, the unintended checkout prevention service 104 determines whether the consumer belongs to a specified range due to being associated with historic unintentional transactions. If not, the unintended checkout prevention service 104 returns GO. If so, the unintended checkout prevention service 104 returns NO GO.

The skilled person will understand that many different rule schemes may be used in place of the above schema depending on the preferences of the issuer 105 and/or the unintended checkout prevention service 104.

When the rule-based unintended checkout prediction result returns GO, the transaction is processed as normal.

In some embodiments, when the unintended checkout prediction result returns NO GO, this result triggers the request of further consumer consent before the transaction can be processed, as described with respect to FIG. 3. In other embodiments, the NO GO result triggers an additional AI-based unintended checkout assessment, as described below.

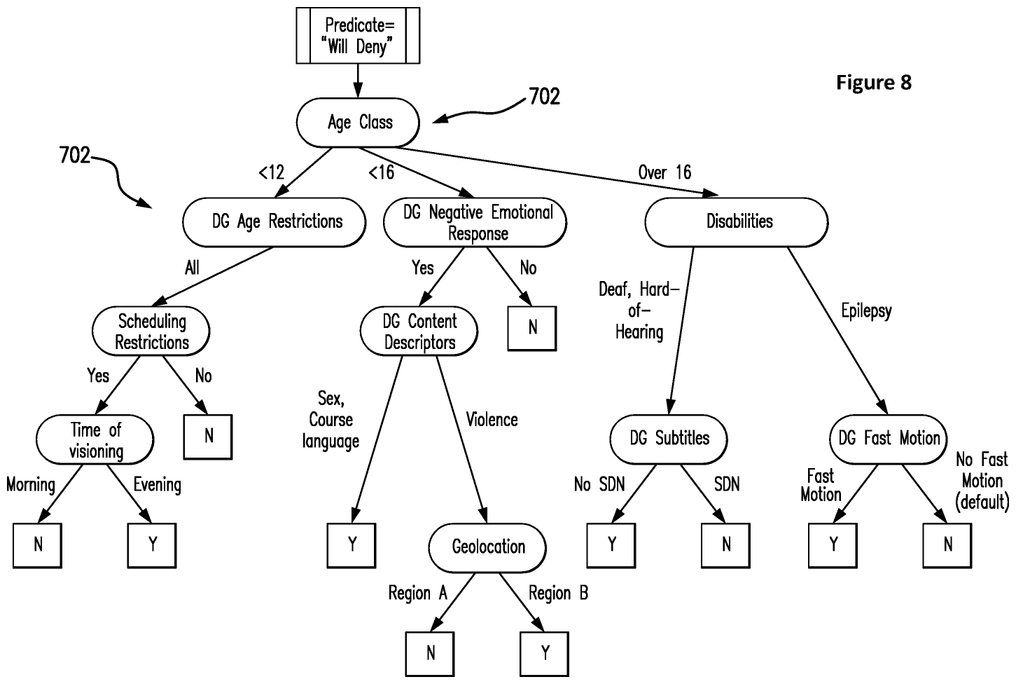

FIG. 7 and FIG. 8 show an exemplary scheme for rule-based decision making suitable for use by an AI-based unintended checkout prediction module 202 in embodiments of the invention.

The AI-based unintended checkout prediction module 202 consists of the following functional blocks:
An adaption module. The adaption module is run “offline”, in the unintended checkout prevention service 104 idle time, when the loading for the real-time processing of transactions is low.
A prediction generation module. The prediction generation module is run online, and it is critical from a time perspective since it provides the prediction result (“YES”/“NO”) to the question “Will the consumer deny the transaction?” In the example described here, the prediction generation module is a Boolean decision tree. The skilled person would understand that more complex modifications of this example could be provided within the scope of the invention.
A decision module. The decision module is run online and decides on the steps to follow the prediction of the prediction generation module. For example, the decision module may decide whether to send an indication that the transaction should continue directly with the approval of the authorization request (since there is deemed to be low risk of the consumer later denying the transaction) or whether to send an indication to obtain explicit consumer consent (as the item is deemed as presenting a high-risk of being denied afterwards) before continuing with the processing of the authorization request.

The adaption module allows the decision tree to be modified over time. The decision tree is initial determined by a learning process based on initial testing set through new experiments, referred to as testing examples. The initial training set may comprise a set of transaction information data entries along with an answer to the question “will the user deny the transaction?” The initial training set may comprise transaction information data from real previous transactions along with the answer regarding whether the consumer later denied the transaction.

The adaption module reduces the large amount of information of the training set to a set of data elements determined to be significant. An example of a reduced training set is shown in FIG. 7, which shows a set of transaction information data entries 701 reduced to a small number of attributes 702 along with a result for whether the consumer is likely to deny the transaction.

The exemplary Boolean decision tree of FIG. 8 is based on the analysis of a hypothetical training set. The adaption algorithm sorts the attribute data of the training set into a tree. The Boolean decision tree provides a scheme for analyzing the transaction information data for each transaction in order to generate an unintended checkout prediction result.

As shown in FIG. 8, the decision tree comprises decision elements that each correspond to a particular attribute 702. Each decision element involves a determination being made regarding its subject attribute 702, with the outcome of the determination governing the path followed through the decision tree.

The number of decision elements in the decision tree, the attribute each decision element is associated with and/or the ordering of the elements in the decision tree is subject to change by the adaptation algorithm. FIG. 8 shows one purely exemplary set of decision elements in an exemplary ordering. Using this example, a person skilled in the art having the benefit of the present disclosure will be able to generate any particular decision tree using the adaption algorithm described above.

In the exemplary decision tree of FIG. 8, for a new example transaction, the AI prediction module 202 first checks the age of the consumer in the anonymized consumer profile of the transaction attribute data. If the consumer is below the age of 16 but not below the age of 12, the AI prediction module 202 then checks whether the digital goods are associated with a negative emotional response in the transaction attribute data. If the answer is yes, the AI prediction module 202 checks which content descriptors for the digital goods are included in the transaction attributes data. If “coarse language” is included in the transaction attributes data, the AI prediction module will return “YES”, that the transaction is high-risk because the consumer is considered likely to deny the transaction.

The structure of the decision tree is updated as new transactions are processed. If a transaction provides an inconsistent testing example due to their being no path in the existing decision tree that leads to a YES/NO value of the decision predicate “Will the consumer deny the transaction?”, then the corresponding testing example is added to a special sub-set of inconsistent experiments. The prediction result for an inconsistent experiment is by default “Yes”, which will trigger a request for explicit consent of the consumer when processing the transaction.

All inconsistent experiments will serve as input for the offline running of a Decision Tree modification algorithm in the adaption module. The running of the adaption module 202 may result in an updated decision tree in which new attributes, which were existent in the previous transaction attributes data but were not provided with a meaning in the decision tree structure, become significant in the prediction analysis.

As described above, if the prediction Result is “NO” (i.e., there is deemed to be a low risk of the consumer subsequently denying having authorized the purchase for the digital goods) then the AI decision module 202 will generate a “Continue” response, indicating that the unintended checkout prevention service 104 and issuer 105 should process the transaction as normal.

If the prediction result is “YES” (i.e., there is deemed to be a high risk of the consumer subsequently denying having authorized the purchase for the digital goods) then the decision module will generate a “Request Consent” response, indicating that the unintended checkout prevention service 104 and issuer 105 should not approve the transaction before further consumer consent is received.

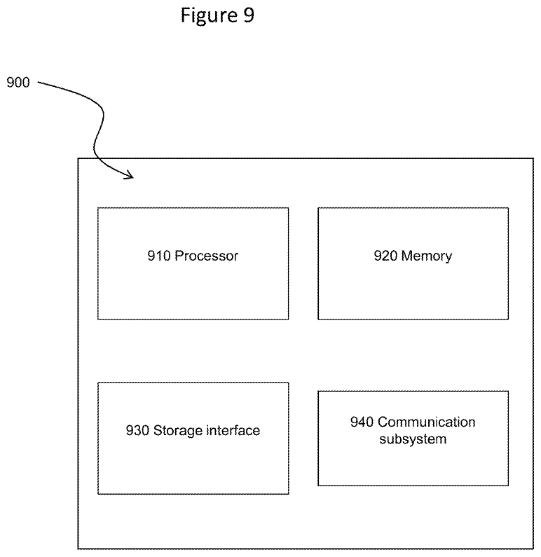

It will be apparent to a person skilled in the art that the methods described herein are all suitable for implementation by one or more data processing devices. By way of example, FIG. 9 shows in schematic form a data processing device 800 that is suitable for performing the functions of any data processing component described above, such as user communication device.

The data processing device 900 includes a processor 910 for executing instructions. Instructions may be stored in a memory 920, for example. Processor 910 may include one or more processing units (e.g., in a multi-core configuration) for executing instructions. The instructions may be executed within a variety of different operating systems on the data processing device 900, such as UNIX, LINUX, Microsoft Windows®, etc.

Processor 910 is operatively coupled to a communication subsystem 940 such that data processing device 900 is capable of communicating with a remote device. Processor 910 may also be operatively coupled to a storage device such as storage medium via storage interface 930. The storage device is any computer-operated hardware suitable for storing and/or retrieving data. In some cases, e.g., a remotely located storage medium, communication subsystem 940 may perform the function of storage interface 930 such that these two entities are combined.

The storage medium can be integrated in data processing device 900, or it can be external to data processing device 900 and located remotely. For example, data processing device 900 may include one or more hard disk drives as a storage device. Alternatively, where the storage device is external to data processing device 900, it can comprise multiple storage units such as hard disks or solid state disks in a redundant array of inexpensive disks (RAID) configuration. The storage device may include a storage area network (SAN) and/or a network attached storage (NAS) system.

Processor 910 can be operatively coupled to the storage device via the storage interface 930. Storage interface 930 is any component capable of providing processor 910 with access to the storage device. Storage interface 830 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 810 with access to the storage device.

Memory 920 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

1. A computer-implemented method for assessing a potentially unintentional transaction relating to the purchase of one or more goods, the method comprising:
receiving, by an unintended checkout prevention service, transaction attribute data from a server of a payment acceptor, the transaction attribute data relating to the transaction;
generating, by the unintended checkout prevention service, an unintended checkout prediction result based on the transaction attribute data;
determining, by the unintended checkout prevention service, that the unintended checkout prediction result is a high-risk result;
generating, by the payment acceptor and in response to the determining, a consumer consent request comprising transaction details relating to the transaction and a request for the consumer to provide authorization data confirming the consumer's consent to the transaction;
sending, by the payment acceptor, the consumer consent request to a consumer device;
receiving, by the payment acceptor, from the consumer device, a consumer consent response in response to the consumer consent request, the consumer consent response comprising authorization data provided by the consumer and the transaction details; and
based on the consumer consent response, approving or declining the transaction.

2. The computer-implemented method of claim 1, wherein the transaction attribute data comprises details of the one or more goods being purchased and an anonymised profile of the consumer.

3. The computer-implemented method of claim 1, wherein sending the consumer consent request to a consumer device comprises sending a request to generate a pop-up window within a browser application executing on the consumer device.

4. The computer-implemented method of claim 1, the method further comprising:
sending, by the unintended checkout prevention service to an issuer, on determining that the unintended checkout prediction result is high-risk, an indication that the transaction should not be approved before receiving consumer consent; and
sending, by the unintended checkout prevention service to the issuer, on successful validation of the authorization data in the consumer consent response, an indication that the transaction authorization can be approved.

5. The computer-implemented method of claim 1, further comprising:
generating, by the payment acceptor, on receiving the consumer consent response, an authorization request for authorization of the transaction; and
sending, from the payment acceptor to an acquirer, the authorization request for forwarding to an issuer.

6. The computer-implemented method of claim 1, further comprising:
generating a one-time password, OTP; and
sending the OTP to the consumer via a trusted channel;
wherein the consumer consent request comprises a request for the consumer to provide the OTP.

7. The computer-implemented of claim 6, wherein the OTP is generated by the unintended checkout prevention service and provided by the unintended checkout prevention service to an issuer for sending to the consumer.

8. The computer-implemented method of claim 6, wherein the OTP is sent to the consumer via an SMS to a telephone number known to be associated with the consumer.

9. The computer-implemented method of claim 1, wherein generating the unintended checkout prediction result is performed by:
analyzing the transaction attribute data according to a predetermined set of rules; and/or
analyzing the transaction attribute data using an artificial intelligence unintended checkout prediction module.

10. The computer-implemented method of claim 1, further comprising:
sending, by the payment acceptor to the unintended checkout prevention service, the consumer consent response; and
storing, by the unintended checkout prevention service, the consumer consent response in a storage medium.

11. The computer-implemented method of claim 10, further comprising:
receiving an indication of an attempt, by the consumer, to repudiate the transaction; and
responsive to the indication, retrieving the consumer consent response from the storage medium.

12. The computer-implemented method of claim 1, further comprising:
verifying, by the unintended checkout prevention service, that the authorization data in the consumer consent response is valid.

13. The computer-implemented method of claim 1, wherein the one or more goods are digital goods.

14. A system comprising one or more processors configured to perform a method comprising:
receiving, by an unintended checkout prevention service, transaction attribute data from a server of a payment acceptor, the transaction attribute data relating to the transaction;
generating, by the unintended checkout prevention service, an unintended checkout prediction result based on the transaction attribute data;
determining, by the unintended checkout prevention service, that the unintended checkout prediction result is a high-risk result;
generating, by the payment acceptor and in response to the determining, a consumer consent request comprising transaction details relating to the transaction and a request for the consumer to provide authorization data confirming the consumer's consent to the transaction;
sending, by the payment acceptor, the consumer consent request to a consumer device;
receiving, by the payment acceptor, from the consumer device, a consumer consent response in response to the consumer consent request, the consumer consent response comprising authorization data provided by the consumer and the transaction details; and
based on the consumer consent response, approving or declining the transaction.

15. A non-transitory computer-readable medium storing computer-readable instructions thereon, the instructions such that, when executed by a processor, the computer-readable instructions cause the processor to perform a method comprising:
receiving, by an unintended checkout prevention service, transaction attribute data from a server of a payment acceptor, the transaction attribute data relating to the transaction;
generating, by the unintended checkout prevention service, an unintended checkout prediction result based on the transaction attribute data;
determining, by the unintended checkout prevention service, that the unintended checkout prediction result is a high-risk result;
generating, by the payment acceptor and in response to the determining, a consumer consent request comprising transaction details relating to the transaction and a request for the consumer to provide authorization data confirming the consumer's consent to the transaction;
sending, by the payment acceptor, the consumer consent request to a consumer device;
receiving, by the payment acceptor, from the consumer device, a consumer consent response in response to the consumer consent request, the consumer consent response comprising authorization data provided by the consumer and the transaction details; and
based on the consumer consent response, approving or declining the transaction.
